(19) United States
(12) Patent Application Publication
(10) Pub. No.: US 2014/0157167 A1
(43) Pub. Date: Jun. 5, 2014

(54) Method and Device for Controlling Icon

(71) Applicant: Huawei Technologies Co., Ltd., Shenzhen (CN)

(72) Inventor: Lijun Zhu, Nanjing (CN)

(73) Assignee: Huawei Technologies Co., Ltd., Shenzhen (CN)

(21) Appl. No.: 14/145,339

(22) Filed: Dec. 31, 2013

Related U.S. Application Data
(63) Continuation of application No. PCT/CN2013/080590, filed on Aug. 1, 2013.

(30) Foreign Application Priority Data
Dec. 5, 2012 (CN) 201210514545.5

(51) Int. Cl. G06F 3/0486; G06F 3/0481

(52) U.S. Cl. CPC G06F 3/0486; G06F 3/04817
USPC 715/769

(57) ABSTRACT

A method for controlling an icon implemented by hardware comprising a processor, including: receiving an operation instruction of dragging a target icon, obtaining stop position information of dragging the target icon from the operation instruction, where the operation instruction includes the stop position information, and controlling the target icon to move from an initial position to an end position according to the stop position information; receiving an operation instruction of releasing the target icon, and controlling the target icon to move from the end position along a direction oriented from the end position to the initial position; and controlling the target icon and other icons in the direction to shake when the target icon moves along the direction to a position that is farthest away from the end position and not occupied by a displayed icon.

### CROSS-REFERENCE TO RELATED APPLICATIONS

This application is a continuation of International Application No. PCT/CN2013/080590, filed on Aug. 1, 2013, which claims priority to Chinese Patent Application No. 201210514545.5, filed on Dec. 5, 2012, both of which are hereby incorporated by reference in their entireties.

### TECHNICAL FIELD

The present disclosure relates to the computer field, and in particular, to a method and a device for controlling an icon.

### BACKGROUND

In a Windows operating system, a user can pin a certain program to a taskbar, and an icon of the application program may be displayed in the taskbar. When the user opens a certain application program, the icon of the application program may also appear in the taskbar.

In the current Windows operating system, an icon in a taskbar can be dragged by a user from an initial position to another position of the taskbar, and, when the user releases the mouse, the dragged icon recovers its initial position.

In the process of dragging the icon, no impact is caused upon other icons in the taskbar, and an effect of materialized presentation of the icon cannot be achieved.

### SUMMARY

Embodiments of the present disclosure provide a method and a device for controlling an icon, which may achieve an effect of materialized presentation of the icon in a process of dragging the icon.

In a first aspect, the present disclosure provides a method for controlling an icon, including: receiving an operation instruction of dragging a target icon, obtaining stop position information of dragging the target icon from the operation instruction, where the operation instruction includes the stop position information, and controlling the target icon to move from an initial position to an end position according to the stop position information; receiving an operation instruction of releasing the target icon, and controlling the target icon to move from the end position along a direction oriented from the end position to the initial position; and controlling the target icon and other icons in the direction to shake when the target icon moves along the direction to a position that is farthest away from the end position and not occupied by a displayed icon.

With reference to the first aspect, in a first possible implementation manner, after receiving the operation instruction of dragging the target icon, the method further includes: monitoring and obtaining a value of a distance of moving the target icon from the initial position to the end position.

Controlling the target icon to move from the end position along a direction oriented from the end position to the initial position includes controlling the target icon to move from the end position along the direction oriented from the end position to the initial position at a speed V, where the V=K×L, the L is a value of a distance between the initial position and the end position, and the K is a preset coefficient.

With reference to the first possible implementation manner of the first aspect, in a second possible implementation manner, controlling the target icon and other icons in the direction to shake includes controlling the target icon and other icons in the direction to shake, where a shake frequency and/or a shake amplitude of the shake are/is proportional to a speed of the target icon moving from the end position along the direction oriented from the end position to the initial position.

With reference to the first aspect or either of the foregoing implementation manners of the first aspect, in a third possible implementation manner, the controlling the target icon and other icons in the direction to shake includes: controlling the target icon and other icons in the direction to shake, where a shake frequency and/or a shake amplitude of the shake are/is inversely proportional to the number of icons in the direction.

With reference to the first aspect or any one of the foregoing implementation manners of the first aspect, in a fourth possible implementation manner, the target icon and other icons in the direction are controlled to shake in a direction that connects a current position and the end position of the target icon.

With reference to the first aspect or any one of the foregoing implementation manners of the first aspect, in a fifth possible implementation manner, the target icon and other icons in the direction are controlled to shake, where a shake frequency and/or a shake amplitude of the shake of each of the other icons in the direction are/is inversely proportional to a distance from each of the other icons in the direction to a position of the target icon before occurrence of the shake.

With reference to the first aspect or any one of the foregoing implementation manners of the first aspect, in a sixth possible implementation manner, after the target icon and other icons in the direction are controlled to shake, the method further includes controlling the target icon and other icons in the direction to stop shaking.

In a second aspect, the present disclosure provides a device for controlling an icon, including a first moving unit, a second moving unit, and a shaking unit, where the first moving unit is configured to receive an operation instruction of dragging a target icon, obtain stop position information of dragging the target icon from the operation instruction, where the operation instruction includes the stop position information, and control the target icon to move from an initial position to an end position according to the stop position information; the second moving unit is configured to receive an operation instruction of releasing the target icon, and control the target icon to move from the end position along a direction oriented from the end position to the initial position; and the shaking unit is connected to the second moving unit, and is configured to control the target icon and other icons in the direction to shake when the second moving unit moves the target icon along the direction to a position that is farthest away from the end position and not occupied by a displayed icon.

With reference to the second aspect, in a first possible implementation manner, the device further includes a monitoring unit, configured to monitor and obtain a value of a distance of moving the target icon from the initial position to the end position, where the second moving unit is specifically configured to receive an operation instruction of releasing the target icon, and control the target icon to move from the end position along the direction oriented from the end position to the initial position at a speed V, where the V=K×L, the L is a value of a distance between the initial position and the end position, and the K is a preset coefficient.

With reference to the first possible implementation manner of the second aspect, in a second possible implementation manner, the shaking unit is specifically configured to control the target icon and other icons in the direction to shake when the target icon moves along the direction to a position that is farthest away from the end position and not occupied by a displayed icon, where a shake frequency and/or a shake amplitude of the shake are/is proportional to a speed of the target icon moving from the end position along the direction oriented from the end position to the initial position.

With reference to the second aspect of either of the foregoing implementation manners of the second aspect, in a third possible implementation manner, the shaking unit is specifically configured to control the target icon and other icons in the direction to shake when the target icon moves along the direction to a position that is farthest away from the end position and not occupied by a displayed icon, where a shake frequency and/or a shake amplitude of the shake are/is inversely proportional to the number of icons in the direction.

With reference to the second aspect or any one of the foregoing implementation manners of the second aspect, in a fourth possible implementation manner, the shaking unit is specifically configured such that when the second moving unit moves the target icon along the direction to a position that is farthest away from the end position and not occupied by a displayed icon, control the target icon and other icons in the direction to shake in a direction that connects a current position and the end position of the target icon.

With reference to the second aspect or any one of the foregoing implementation manners of the second aspect, in a fifth possible implementation manner, the shaking unit is specifically configured to control the target icon and other icons in the direction to shake when the second moving unit moves the target icon along the direction to a position that is farthest away from the end position and not occupied by a displayed icon, where a shake frequency and/or a shake amplitude of each of the other icons in the direction are/is inversely proportional to a distance from each of the other icons in the direction to a position of the target icon before occurrence of the shake.

With reference to the second aspect of any one of the foregoing implementation manners of the second aspect, in a sixth possible implementation manner, the shaking unit is specifically configured to control the target icon and other icons in the direction to shake when the second moving unit moves the target icon along the direction to a position that is farthest away from the end position and not occupied by a displayed icon, where a shake frequency and/or a shake amplitude of each of the other icons in the direction are/is inversely proportional to a distance from each of the other icons in the direction to a position of the target icon before occurrence of the shake.

In the foregoing technical solutions, an operation instruction of dragging a target icon is received, stop position information of dragging the target icon is obtained from the operation instruction, where the operation instruction includes the stop position information, and the target icon is controlled to move from an initial position to an end position according to the stop position information; an operation instruction of releasing the target icon is received, and the target icon is controlled to move from the end position along a direction oriented from the end position to the initial position; and the target icon and other icons in the direction are controlled to shake when the target icon moves along the direction to a position that is farthest away from the end position and not occupied by a displayed icon. In this way, an effect of the target icon impacting other icons in the direction is generated, and therefore, an effect of materialized presentation of the icon is achieved in the process of dragging the icon.

### BRIEF DESCRIPTION OF DRAWINGS

To illustrate the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of a method for controlling an icon according to an embodiment of the present disclosure;

FIG. 2 is a schematic flowchart of another method for controlling an icon according to an embodiment of the present disclosure;

FIG. 3 is a schematic diagram of moving an icon according to an embodiment of the present disclosure;

FIG. 4 is another schematic diagram of moving an icon according to an embodiment of the present disclosure;

FIG. 5 is another schematic diagram of moving an icon according to an embodiment of the present disclosure;

FIG. 6 is a schematic structural diagram of a device for controlling an icon according to an embodiment of the present disclosure;

FIG. 7 is a schematic structural diagram of another device for controlling an icon according to an embodiment of the present disclosure; and

FIG. 8 is a schematic structural diagram of a computer system according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely a part, rather than all, of the embodiments of the present disclosure. All other embodiments obtained by a person of ordinary skill in the art based on the embodiments of the present disclosure without creative efforts shall fall within the protection scope of the present disclosure.

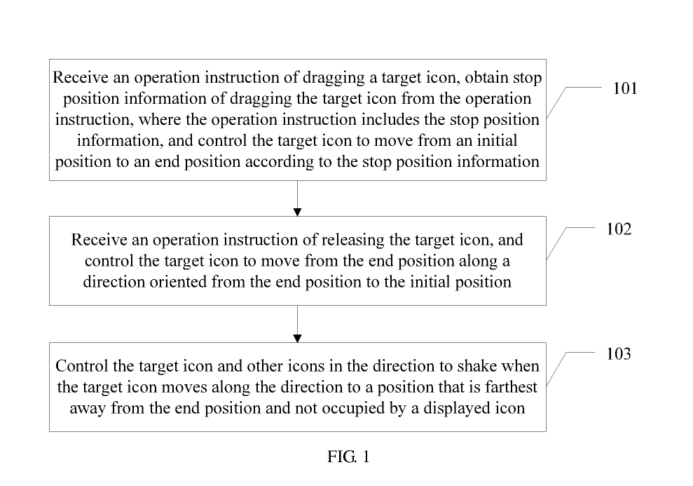

FIG. 1 is a schematic flowchart of a method for controlling an icon according to an embodiment of the present disclosure. It should be understood that the icon in this embodiment includes but is not limited to an icon that represents an application program. As shown in FIG. 1, the method includes the following steps:

101. Receive an operation instruction of dragging a target icon, obtain stop position information of dragging the target icon from the operation instruction, where the operation instruction includes the stop position information, and control the target icon to move from an initial position to an end position according to the stop position information.

102. Receive an operation instruction of releasing the target icon, and control the target icon to move from the end position along a direction oriented from the end position to the initial position.

103. Control the target icon and other icons in the direction to shake when the target icon moves along the direction to a position that is farthest away from the end position and not occupied by a displayed icon.

It should be noted that the method may specifically be applied to a device that supports icon dragging, such as a computer or a mobile phone.

In the foregoing technical solution, an operation instruction of dragging a target icon is received, stop position information of dragging the target icon is obtained from the operation instruction, where the operation instruction includes the stop position information, and the target icon is controlled to move from an initial position to an end position according to the stop position information; an operation instruction of releasing the target icon is received, and the target icon is controlled to move from the end position along a direction oriented from the end position to the initial position; and the target icon and other icons in the direction are controlled to shake when the target icon moves along the direction to a position that is farthest away from the end position and not occupied by a displayed icon. In this way, an effect of the target icon impacting other icons in the direction is generated, and therefore, an effect of materialized presentation of the icon is achieved in the process of dragging the icon.

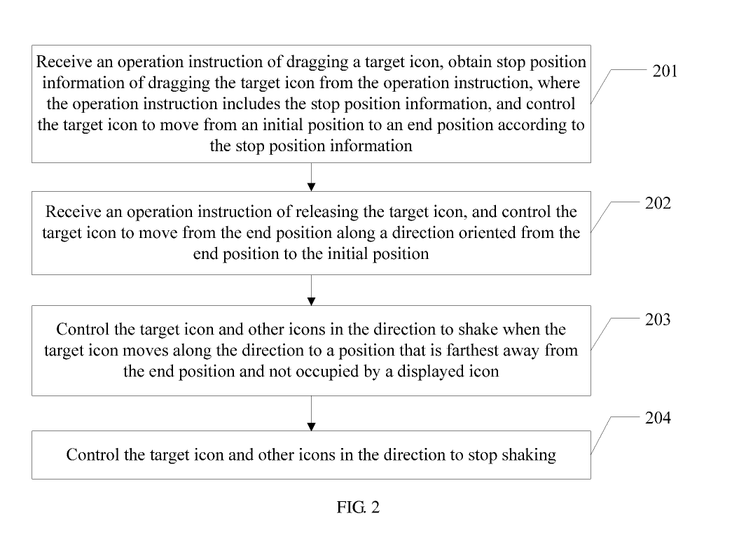

FIG. 2 is a schematic flowchart of another method for controlling an icon according to an embodiment of the present disclosure. As shown in FIG. 2, the method includes the following steps:

201. Receive an operation instruction of dragging a target icon, obtain stop position information of dragging the target icon from the operation instruction, where the operation instruction includes the stop position information, and control the target icon to move from an initial position to an end position according to the stop position information.

Optionally, the end position may be a stop position corresponding to a stop position information. When the stop position corresponding to the stop position information goes beyond a display border of a device for implementing the present disclosure, the end position may be a display border position of the device.

Optionally, the target icon may specifically be an icon displayed in a taskbar of a computer, but the target icon in the present disclosure is not limited to an icon displayed in a taskbar of a computer, and may also be an icon on a mobile phone interface, for example.

202. Receive an operation instruction of releasing the target icon, and control the target icon to move from the end position along a direction oriented from the end position to the initial position.

203. Control the target icon and other icons in the direction to shake when the target icon moves along the direction to a position that is farthest away from the end position and not occupied by a displayed icon.

In an optional implementation manner, a shake frequency and/or a shake amplitude of the shake are/is proportional to a speed of the target icon moving from the end position along the direction oriented from the end position to the initial position, and the shake frequency and/or the shake amplitude of the shake are/is inversely proportional to the number of icons in the direction.

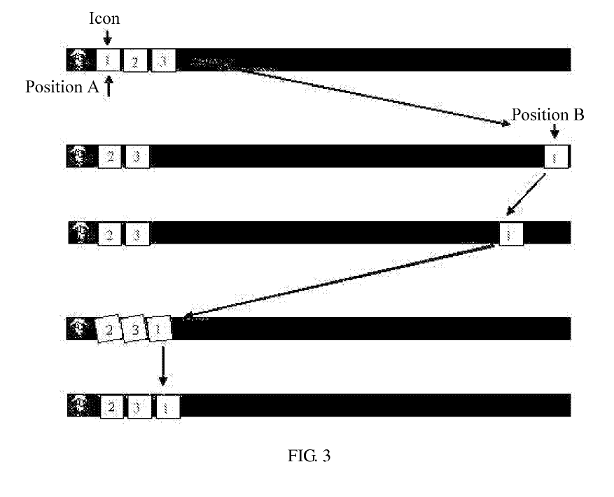

For example, the target icon is an icon displayed in a taskbar of a computer, and the taskbar displays three icons. As shown in FIG. 3, the icons are icon 1, icon 2, and icon 3 consecutively from left to right. When the target icon is icon 1 (position A), operation information input by a user is received in step 201, and icon 1 is controlled to move to the end position B. Assuming that the end position is on the right side of the taskbar, in the dragging process, because icon 1 is dragged, icon 2 and icon 3 may move leftward by an icon display position consecutively, that is, icon 2 and icon 3 are moved to an original position of icon 1 and that of icon 2, respectively. In step 202, icon 1 is controlled to move from the end position along the direction oriented from the end position to the initial position, that is, to move from right to left. In step 203, the target icon moves along the direction to a position that is farthest away from the end position and not occupied by a displayed icon, that is, a position occupied by icon 3 before step 201 is performed. When the target icon is controlled to move to this position in step 202, the target icon and other icons in the direction are controlled to shake in step 203. In this way, it seems to the user that icon 1 is impacting icon 3 and icon 2. When icon 1 impacts icon 3 and icon 2, icon 1, icon 2, and icon 3 are all shaking.

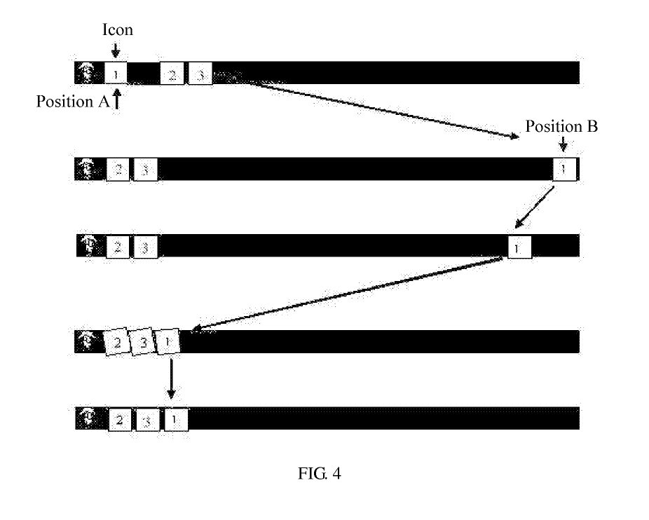

Optionally, as shown in FIG. 4, if a position unoccupied by displayed icons exists between the displayed icons, such as a position between icon 1 and icon 2 in FIG. 4, after icon 1 is dragged in step 101, icon 2 is moved to a position of icon 1, and icon 3 is moved to the position unoccupied by the displayed icons, and then in step 203, icon 1 is controlled to move to an original position of icon 2. Nevertheless, in the present disclosure, after icon 1 is dragged in step 101, icon 2 is moved to the original position of icon 1, and icon 3 is moved to the original position of icon 2, that is, the position unoccupied by the displayed icons is reserved, and then in step 203, icon 1 is controlled to move to an original position of icon 3.

Optionally, when the foregoing process occurs more quickly, the shake frequency and/or the shake amplitude of the shake are/is greater; and, when the number of icons in the direction is larger, the shake frequency and/or the shake amplitude of the shake are/is smaller.

It should be noted that when the target icon moves from the end position along the direction, the target icon and the icons in the direction are controlled to shake in step 203, giving the user an effect similar to that of impacting objects. For example, when the target icon impacts other icons in the direction, the target icon and other icons in the direction are shaking.

204. Control the target icon and other icons in the direction to stop shaking.

It should be noted that step 204 may specifically be performed after completion of the shaking in step 203. In this way, the user is given an effect that the target icon is impacting other icons in the direction, and the icons are shaking and then stop shaking.

In an optional implementation manner, after step 201, the method may further include: monitoring and obtaining a value of a distance of moving the target icon from the initial position to the end position.

Optionally, in this implementation manner, step 202 may specifically include: receiving an operation instruction of releasing the target icon, and controlling the target icon to move from the end position along the direction oriented from the end position to the initial position at a speed V, where the V=K×L, the L is a value of a distance between the initial position and the end position, and the K is a preset coefficient.

In this implementation manner, when the distance between the initial position and the end position is longer, the foregoing speed is higher, and therefore the shake frequency and/or the shake amplitude of the shake are/is greater.

In an optional implementation manner, step 203 may specifically include:

When the target icon moves along the direction to the position that is farthest away from the end position and not occupied by a displayed icon, controlling the target icon and other icons in the direction to shake in a direction that connects a current position and the end position of the target icon, where the shake frequency and/or the shake amplitude of the shake are/is proportional to a speed of the target icon moving from the end position along the direction oriented from the end position to the initial position, and the shake frequency and/or the shake amplitude of the shake are/is inversely proportional to the number of icons in the direction.

Optionally, the shake may be a round-trip one. For example, when the direction of the connection line is a horizontal direction, the shake may be shaking left and right in the horizontal direction by using the current position of the icon as an origin, and, when the direction of the connection line is a vertical direction, the shake may be shaking up and down in the vertical direction by using the current position of the icon as an origin.

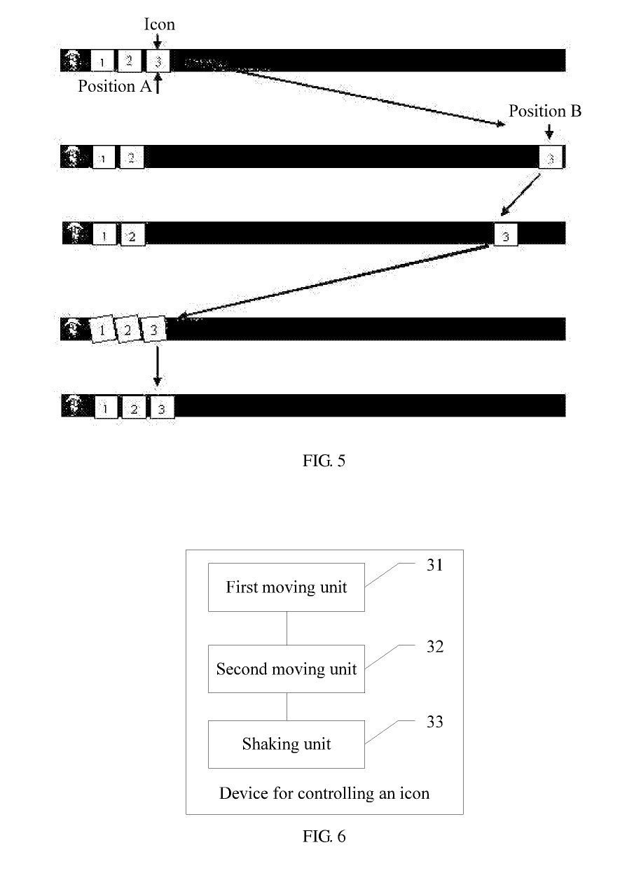

Specifically, as shown in FIG. 5, the target icon is icon 3, and the icons in the direction include icon 1 and icon 2; in step 201, icon 3 is controlled to move to the end position (position B in FIG. 5); in step 202, icon 3 is controlled to move along the direction; in step 203, when the target icon moves along the direction to the position (position A in FIG. 5) that is farthest away from the end position and not occupied by a displayed icon, icon 1, icon 2, and icon 3 are controlled to shake (as shown in row 4 of FIG. 5); and, in step 204, icon 1, icon 2, and icon 3 are controlled to return to positions occupied before occurrence of the shake (as shown in row 5 of FIG. 5).

In an optional implementation manner, step 203 may specifically include: controlling the target icon and other icons in the direction to shake when the target icon is moved along the direction to the position that is farthest away from the end position and not occupied by a displayed icon, where a shake frequency and/or a shake amplitude of each of the other icons in the direction are/is inversely proportional to a distance from each of the other icons in the direction to a position occupied by the target icon before occurrence of the first move.

In this implementation manner, the shake frequency and/or the shake amplitude of the shake may vary between icons in different positions. For example, if the distance from icon 2 to the position occupied by icon 3 before occurrence of the first move is shorter than the distance from icon 1 to the position occupied by icon 3 before occurrence of the shake, the shake frequency and/or the shake amplitude of the shake of icon 2 are/is greater than the shake frequency and/or the shake amplitude of the shake of icon 1.

In an optional implementation manner, the shake may be a shake toward the direction first, and then toward an opposite direction of the direction. The shake may also be repeated shakes. If the direction points leftward, the opposite direction of the direction points rightward, and the shake may be left-and-right shakes. After each shake, the shake frequency and/or the shake amplitude of the shake decrease(s) correspondingly.

It should be noted that, when the target icon is an icon displayed in a taskbar of a computer, other icons in the direction refer to only the icons in the taskbar in the direction rather than other icons (such as a Startup icon) in the direction.

In the foregoing technical solution, on the basis of the foregoing embodiment, a step of controlling the target icon and other icons in the direction to stop shaking is added, giving the user an effect that the target icon is impacting other icons in the direction, and the icons are shaking and then stop shaking. In addition, an effect of materialized presentation of the icon can be achieved in the process of dragging the icon.

The following describes an apparatus embodiment of the present disclosure. The apparatus embodiment of the present disclosure is used to implement the method implemented in method embodiments 1 to 2 of the present disclosure. For ease of description, only the part related to the embodiment of the present disclosure is illustrated. For technical details that are not disclosed here, refer to embodiment 1 and embodiment 2 of the present disclosure.

FIG. 6 is a schematic structural diagram of a device for controlling an icon according to an embodiment of the present disclosure. As shown in FIG. 6, the device includes a first moving unit 31, a second moving unit 32, and a shaking unit 33, where the first moving unit 31 is configured to: receive an operation instruction of dragging a target icon, obtain stop position information of dragging the target icon from the operation instruction, where the operation instruction includes the stop position information, and control the target icon to move from an initial position to an end position according to the stop position information; the second moving unit 32 is configured to receive an operation instruction of releasing the target icon, and control the target icon to move from the end position along a direction oriented from the end position to the initial position; and the shaking unit 33 is connected to the second moving unit 32, and is configured to control the target icon and other icons in the direction to shake when the second moving unit 32 controls the target icon to move along the direction to a position that is farthest away from the end position and not occupied by a displayed icon.

It should be noted that the device may specifically be a device that supports icon dragging, such as a computer or a mobile phone.

In the foregoing technical solution, an operation instruction of dragging a target icon is received, stop position information of dragging the target icon is obtained from the operation instruction, where the operation instruction includes the stop position information, and the target icon is controlled to move from an initial position to an end position according to the stop position information; an operation instruction of releasing the target icon is received, and the target icon is controlled to move from the end position along a direction oriented from the end position to the initial position; and the target icon and other icons in the direction are controlled to shake when the target icon moves along the direction to a position that is farthest away from the end position and not occupied by a displayed icon. In this way, an effect of the target icon impacting other icons in the direction is generated, and therefore, an effect of materialized presentation of the icon is achieved in the process of dragging the icon.

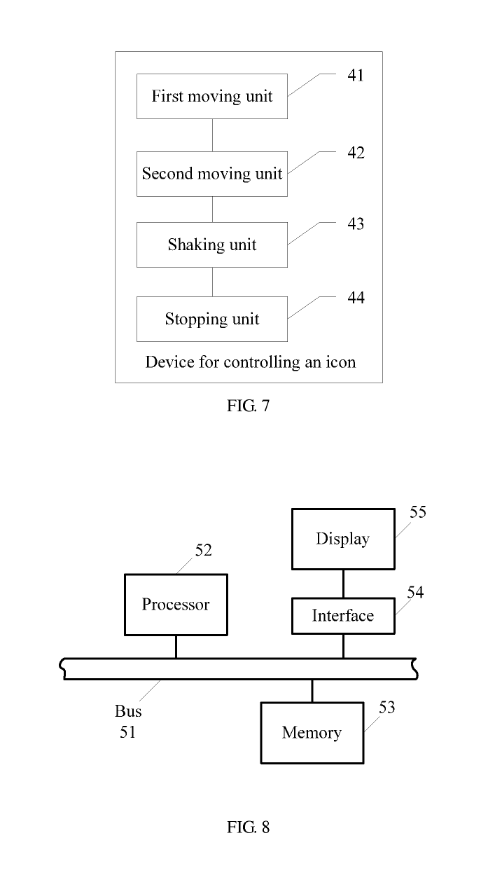

FIG. 7 is a schematic structural diagram of another device for controlling an icon according to an embodiment of the present disclosure. As shown in FIG. 7, the device includes a first moving unit 41, a second moving unit 42, a shaking unit 43, and a stopping unit 44.

The first moving unit 41 is configured to: receive an operation instruction of dragging a target icon, obtain stop position information of dragging the target icon from the operation instruction, where the operation instruction includes the stop position information, and control the target icon to move from an initial position to an end position according to the stop position information.

Optionally, the target icon may specifically be an icon displayed in a taskbar of a computer, but the target icon in the present disclosure is not limited to an icon displayed in a taskbar of a computer, and may also be an icon on a mobile phone interface, for example.

The second moving unit 42 is configured to receive an operation instruction of releasing the target icon, and control the target icon to move from the end position along a direction oriented from the end position to the initial position.

The shaking unit 43 is connected to the second moving unit 42, and is configured to control the target icon and other icons in the direction to shake when the second moving unit 42 controls the target icon to move along the direction to a position that is farthest away from the end position and not occupied by a displayed icon.

In an optional implementation manner, a shake frequency and/or a shake amplitude of the shake are/is proportional to a speed of the target icon moving from the end position along the direction oriented from the end position to the initial position, and the shake frequency and/or the shake amplitude of the shake are/is inversely proportional to the number of icons in the direction.

For example, the target icon is an icon displayed in a taskbar of a computer, and the taskbar displays three icons. As shown in FIG. 3, the icons are icon 1, icon 2, and icon 3 consecutively from left to right. When the target icon is icon 1, the first moving unit 41 receives operation information input by the user, and controls icon 1 to move to the end position. Assuming that the end position is on the right side of the taskbar, in the dragging process, because icon 1 is dragged, icon 2 and icon 3 may move leftward by an icon display position consecutively, that is, icon 2 and icon 3 are moved to an original position of icon 1 and that of icon 2 respectively. The second moving unit 42 controls icon 1 to move from the end position along the direction oriented from the end position to the initial position, that is, to move from right to left. The target icon moves along the direction to a position that is farthest away from the end position and not occupied by a displayed icon, that is, a position occupied by icon 3 before the first moving unit 41 performs the moving. When the second moving unit 42 controls the target icon to move to this position, the shaking unit 43 controls the target icon and other icons in the direction to shake. In this way, it seems to the user that icon 1 is impacting icon 3 and icon 2. When icon 1 impacts icon 3 and icon 2, icon 1, icon 2, and icon 3 are all shaking.

Optionally, when the foregoing process occurs more quickly, the shake frequency and/or the shake amplitude of the shake are/is greater; and, when the number of icons in the direction is larger, the shake frequency and/or the shake amplitude of the shake are/is smaller.

It should be noted that when the target icon moves from the end position along the direction, the shaking unit 43 controls the target icon and the icons in the direction to shake, giving the user an effect similar to that of impacting objects. For example, when the target icon impacts other icons in the direction, the target icon and other icons in the direction are shaking.

The stopping unit 44 is configured to control the target icon and other icons in the direction to stop shaking after the shaking unit 43 controls the target icon and other icons in the direction to shake.

In an optional implementation manner, the device may further include a monitoring unit (not illustrated in the accompanying drawing), configured to monitor and obtain a value of a distance of moving the target icon from the initial position to the end position.

The second moving unit 42 may be further specifically configured to receive an operation instruction of releasing the target icon, and control the target icon to move from the end position along the direction oriented from the end position to the initial position at a speed V, where the V=K×L, the L is a value of a distance between the initial position and the end position, and the K is a preset coefficient.

In this implementation manner, when the distance between the initial position and the end position is longer, the foregoing speed is higher, and therefore the shake frequency and/or the shake amplitude of the shake are/is greater.

In an optional implementation manner, specifically, the shaking unit 43 may further be configured to: when the second moving unit 42 controls the target icon to move along the direction to the position that is farthest away from the end position and not occupied by a displayed icon, control the target icon and other icons in the direction to shake in a direction that connects a current position and the end position of the target icon, where the shake frequency and/or the shake amplitude of the shake are/is proportional to a speed of the target icon moving from the end position along the direction oriented from the end position to the initial position, and the shake frequency and/or the shake amplitude of the shake are/is inversely proportional to the number of icons in the direction.

Specifically, as shown in FIG. 5, the target icon is icon 3, and the icons in the direction include icon 1 and icon 2; the first moving unit 41 controls icon 3 to move to the end position (position B in FIG. 5); the second moving unit 42 controls icon 3 to move along the direction; when the target icon moves along the direction to the position (position A in FIG. 5) that is farthest away from the end position and not occupied by a displayed icon, the shaking unit 43 controls icon 1, icon 2, and icon 3 to shake (as shown in row 4 of FIG. 5); and, the stopping unit 44 controls icon 1, icon 2, and icon 3 to return to positions occupied before occurrence of the shake (as shown in row 5 of FIG. 5).

In an optional implementation manner, specifically, the shaking unit 43 may further be configured to control the target icon and other icons in the direction to shake when the second moving unit 42 controls the target icon to move along the direction to the position that is farthest away from the end position and not occupied by a displayed icon, where a shake frequency and/or a shake amplitude of each of the other icons in the direction are/is inversely proportional to a distance from each of the other icons in the direction to a position of the target icon before occurrence of the first move.

In this implementation manner, the shake frequency and/or the shake amplitude of the shake may vary between icons in different positions. For example, if the distance from icon 2 to the position occupied by icon 3 before occurrence of the first move is shorter than the distance from icon 1 to the position occupied by icon 3 before occurrence of the shake, the shake frequency and/or the shake amplitude of the shake of icon 2 are/is greater than the shake frequency and/or the shake amplitude of the shake of icon 1.

In an optional implementation manner, the shake may be a shake toward a first direction, and then toward an opposite direction of the direction. The shake may also be repeated shakes. If the direction points leftward, the opposite direction of the direction points rightward, and the shake may be left-and-right shakes. After each shake, the shake frequency and/or the shake amplitude of the shake decrease(s) correspondingly.

It should be noted that, when the target icon is an icon displayed in a taskbar of a computer, other icons in the direction refer to only the icons in the taskbar in the direction rather than other icons (such as a Startup icon) in the direction.

In the foregoing technical solution, on the basis of the foregoing embodiment, the stopping unit controls the target icon and other icons in the direction to stop shaking, giving the user an effect that the target icon is impacting other icons in the direction, and the icons are shaking and then stop shaking. In addition, an effect of materialized presentation of the icon can be achieved in the process of dragging the icon.

FIG. 8 is a schematic structural diagram of a computer system according to an embodiment of the present disclosure. As shown in FIG. 8, the computer system in this embodiment may include a bus 51, a processor 52 connected to the bus 51, and a memory 53 connected to the bus 51. The processor 52 uses the bus to call codes stored in the memory 53 to: receive an operation instruction of dragging a target icon, and control the target icon to move from an initial position to an end position; receive an operation instruction of releasing the target icon, and control the target icon to move from the end position along a direction oriented from the end position to the initial position; and control the target icon and other displayed icons in the direction to shake when the target icon moves along the direction to a position that is farthest away from the end position and not occupied by a displayed icon.

In another embodiment of the present disclosure, the computer system further includes an interface 54 connected to the bus 51, where the interface 54 is connected to a display 55.

The display 55 is configured to display a screen state when the target icon moves from the initial position to the end position, a screen state when the target icon moves from the end position along the direction oriented from the end position to the initial position, or a screen state/effect when the target icon and other icons in the direction shake.

In another embodiment of the present disclosure, after controlling the target icon and other icons in the direction to shake, the processor 52 is further configured to control the target icon and other icons in the direction to stop shaking.

Specifically, in this embodiment, the display 55 may display a screen state/effect of controlling the target icon and other icons in the direction to stop shaking. In this way, a user is given an effect that the target icon is impacting other icons in the direction, and the icons are shaking and then stop shaking.

In another embodiment of the present disclosure, after receiving an operation instruction of dragging a target icon, the processor 52 is further configured to monitor and obtain a value of a distance of moving the target icon from the initial position to the end position.

Controlling, by the processor 52, the target icon to move from the end position along a direction oriented from the end position to the initial position, may specifically include controlling the target icon to move from the end position along the direction oriented from the end position to the initial position at a speed V, where the V=K×L, the L is a value of a distance between the initial position and the end position, and the K is a preset coefficient.

In this embodiment, when the distance between the initial position and the end position is longer, the foregoing speed is higher, and therefore the shake frequency and/or the shake amplitude of the shake are/is greater.

In another embodiment of the present disclosure, controlling, by the processor 52, the target icon and other icons in the direction to shake when the target icon moves along the direction to a position that is farthest away from the end position and not occupied by a displayed icon, may specifically include: when the target icon moves along the direction to the position that is farthest away from the end position and not occupied by a displayed icon, controlling the target icon and other icons in the direction to shake in a direction that connects a current position and the end position of the target icon, where the shake frequency and/or the shake amplitude of the shake are/is proportional to a speed of the target icon moving from the end position along the direction oriented from the end position to the initial position, and the shake frequency and/or the shake amplitude of the shake are/is inversely proportional to the number of icons in the direction.

In another embodiment of the present disclosure, controlling, by the processor 52, the target icon and other icons in the direction to shake when the target icon moves along the direction to a position that is farthest away from the end position and not occupied by a displayed icon, may specifically include: controlling the target icon and other icons in the direction to shake when the second moving unit moves the target icon along the direction to the position that is farthest away from the end position and not occupied by a displayed icon, where a shake frequency and/or a shake amplitude of each of the other icons in the direction are/is inversely proportional to a distance from each of the other icons in the direction to a position occupied by the target icon before occurrence of the first move.

In this embodiment, the shake frequency and/or the shake amplitude of the shake may vary between icons in different positions. As shown in FIG. 5, if the distance from icon 2 to the position occupied by icon 3 before occurrence of the first move is shorter than the distance from icon 1 to the position occupied by icon 3 before occurrence of the shake, the shake frequency and/or the shake amplitude of the shake of icon 2 are/is greater than the shake frequency and/or the shake amplitude of the shake of icon 2.

In another embodiment of the present disclosure, the shake may be a shake toward the first direction, and then toward an opposite direction of the direction. The shake may also be repeated shakes. If the directions points leftward, the opposite direction of the direction points rightward, and the shake may be left-and-right shakes. After each shake, the shake frequency and/or the shake amplitude of the shake decrease(s) correspondingly.

It should be noted that, when the target icon is an icon displayed in a taskbar of a computer, other icons in the direction refer to only the icons in the taskbar in the direction rather than other icons (such as a Startup icon) in the direction.

In the foregoing technical solution, an operation instruction of dragging a target icon is received, the target icon is controlled to move from an initial position to an end position according to stop position information; an operation instruction of releasing the target icon is received, and the target icon is controlled to move from the end position along a direction oriented from the end position to the initial position; and the target icon and other icons in the direction are controlled to shake when the target icon moves along the direction to a position that is farthest away from the end position and not occupied by a displayed icon. In this way, an effect of the target icon impacting other icons in the direction is generated, and therefore, an effect of materialized presentation of the icon is achieved in the process of dragging the icon.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The storage medium may be a magnetic disc, an optical disc, a read-only memory (ROM), or a random access memory (RAM).

The foregoing descriptions are merely exemplary embodiments of the present disclosure, but are not intended to limit the protection scope of the present disclosure. Therefore, any equivalent variation made according to the claims of the present disclosure shall fall within the protection scope of the present disclosure.

What is claimed is:

1. A method for controlling an icon implemented by hardware comprising a processor, comprising:
receiving an operation instruction of dragging a target icon, wherein the operation instruction comprises stop position information;
obtaining the stop position information of dragging the target icon from the operation instruction;
controlling the target icon to move from an initial position to an end position according to the stop position information;
receiving an operation instruction of releasing the target icon;
controlling the target icon to move from the end position along a direction oriented from the end position to the initial position according to the operation instruction of releasing the target icon; and
controlling the target icon and other displayed icons in the direction to shake when the target icon moves along the direction to a position that is farthest away from the end position and not occupied by a displayed icon.

2. The method according to claim 1, wherein after the receiving the operation instruction of dragging the target icon, the method further comprises monitoring and obtaining a value of a distance of moving the target icon from the initial position to the end position, wherein controlling the target icon to move from the end position along the direction oriented from the end position to the initial position comprises controlling the target icon to move from the end position along the direction oriented from the end position to the initial position at a speed V, wherein V=K×L, wherein L is a value of a distance between the initial position and the end position, and wherein K is a preset coefficient.

3. The method according to claim 2, wherein controlling the target icon and other icons in the direction to shake comprises controlling the target icon and other icons in the direction to shake, and wherein a shake frequency and a shake amplitude of the shake are proportional to a speed of the target icon moving from the end position along the direction oriented from the end position to the initial position.

4. The method according to claim 2, wherein controlling the target icon and other icons in the direction to shake comprises controlling the target icon and other icons in the direction to shake, and wherein a shake frequency of the shake is proportional to a speed of the target icon moving from the end position along the direction oriented from the end position to the initial position.

5. The method according to claim 2, wherein controlling the target icon and other icons in the direction to shake comprises controlling the target icon and other icons in the direction to shake, and wherein a shake amplitude of the shake is proportional to a speed of the target icon moving from the end position along the direction oriented from the end position to the initial position.

6. The method according to claim 1, wherein a shake frequency and a shake amplitude of the shake are inversely proportional to the number of icons in the direction.

7. The method according to claim 1, wherein a shake frequency of the shake is inversely proportional to the number of icons in the direction.

8. The method according to claim 1, wherein a shake amplitude of the shake is inversely proportional to the number of icons in the direction.

9. The method according to claim 1, wherein the shake is performed in a direction that connects a current position and the end position of the target icon.

10. The method according to claim 1, wherein a shake frequency and/or a shake amplitude of the shake of each of the other icons in the direction are/is inversely proportional to a distance from each of the other icons in the direction to a position of the target icon before occurrence of the shake.

11. The method according to claim 1, wherein after controlling the target icon and other displayed icons in the direction to shake, the method further comprises: controlling the target icon and other icons in the direction to stop shaking.

12. A device for controlling an icon, comprising:
a first moving unit configured to:
receive an operation instruction of dragging a target icon, wherein the operation instruction comprises stop position information;
obtain the stop position information of dragging the target icon from the operation instruction; and
control the target icon to move from an initial position to an end position according to the stop position information;
a second moving unit configured to:
receive an operation instruction of releasing the target icon; and
control the target icon to move from the end position along a direction oriented from the end position to the initial position according to the operation instruction of releasing the target icon;
a shaking unit connected to the second moving unit and is configured to control the target icon and other icons in the direction to shake when the second moving unit controls the target icon to move along the direction to a position that is farthest away from the end position and not occupied by a displayed icon; and
a processor coupled to the first moving unit, the second moving unit and the shaking unit.

13. The device according to claim 12, wherein the device further comprises a monitoring unit configured to monitor and obtain a value of a distance of moving the target icon from the initial position to the end position, wherein the second moving unit is configured to receive an operation instruction of releasing the target icon and control the target icon to move from the end position along the direction oriented from the end position to the initial position at a speed V, wherein V=K×L, wherein L is a value of a distance between the initial position and the end position, and wherein K is a preset coefficient.

14. The device according to claim 13, wherein the shaking unit is configured to control the target icon and other icons in the direction to shake when the target icon moves along the direction to the position that is farthest away from the end position and not occupied by a displayed icon, and wherein a shake frequency and/or a shake amplitude of the shake are/is proportional to a speed of the target icon moving from the end position along the direction oriented from the end position to the initial position.

15. The device according to claim 12, wherein the shaking unit is configured to control the target icon and other icons in the direction to shake when the target icon moves along the direction to the position that is farthest away from the end position and not occupied by a displayed icon, and wherein a shake frequency and/or a shake amplitude of the shake are/is inversely proportional to the number of icons in the direction.

16. The device according to claim 12, wherein the shaking unit is configured to control the target icon and other icons in the direction to shake in a direction that connects a current position and the end position of the target icon when the second moving unit moves the target icon along the direction to the position that is farthest away from the end position and not occupied by a displayed icon.

17. The device according to claim 12, wherein the shaking unit is configured to control the target icon and other icons in the direction to shake when the second moving unit moves the target icon along the direction to the position that is farthest away from the end position and not occupied by a displayed icon, and wherein a shake frequency and/or a shake amplitude of each of the other icons in the direction are/is inversely proportional to a distance from each of the other icons in the direction to a position of the target icon before occurrence of the shake.

18. The device according to claim 12, wherein the device further comprises: a stopping unit, configured to control the target icon and other icons in the direction to stop shaking after the shaking unit controls the target icon and other icons in the direction to shake.
